(19) United States
(12) Patent Application Publication
(10) Pub. No.: US 2007/0291338 A1
(43) Pub. Date: Dec. 20, 2007

(54) Photo editing menu systems for digital cameras

(76) Inventors: Karen E. Williams, Ft. Collins, CO (US); Robert P. Cazier, Ft. Collins, CO (US); Angelica A. Quintana, Rio Rancho, NM (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/471,228

(22) Filed: Jun. 20, 2006

(51) Int. Cl. G06K 15/00

(52) U.S. Cl. 358/537; 358/1.12; 358/302

(57) ABSTRACT

Photo editing menu systems for digital cameras are disclosed. In an exemplary implementation, a method for applying creative effects to digital images with minimal user effort may comprise displaying an image editing menu as a layer over a digital image displayed on a camera. The method may also comprise receiving user input identifying at least one selection from the image editing menu. The method may also comprise applying at least one of the creative effects to the digital image displayed on the camera based on the at least one selection from the image editing menu.

### BACKGROUND

Conventional film and more recently, digital cameras, are widely commercially available, ranging both in price and in operation from sophisticated single lens reflex (SLR) cameras used by professional photographers to inexpensive “point-and-shoot” cameras that nearly anyone can use with relative ease. Digital cameras are available with user interfaces that enable a user to select various camera features (e.g., ISO speed and red-eye removal).

However, digital camera users need to download their photos to a personal computer (PC) and use photo editing software before they can add creative effects (e.g., borders and color tones) to their digital images. Photo editing software can be fairly sophisticated, expensive, and time-consuming to use, so many users forgo adding creative effects to their digital images.

### BRIEF DESCRIPTION OF THE DRAWINGS

FIG. 1 is a block diagram of an exemplary digital camera which may implement photo editing menu systems.

FIG. 2 is a process flow diagram illustrating implementation of exemplary photo editing menu systems in a digital camera.

FIG. 3 are screenshots of a user interface illustrating (a) an exemplary design gallery menu, and (b) a highlighted selection in the exemplary design gallery menu.

FIG. 4 are screenshots of a user interface illustrating (a) an exemplary apply artistic effects menu, (b) an exemplary modify color menu, and (c) an exemplary add borders menu.

FIG. 5 is a screenshot showing an exemplary preview image as it may be displayed for a user on a digital camera implementing photo editing menu

FIG. 6 is a flowchart illustrating exemplary operations which may implement photo editing menu systems for digital cameras.

### DETAILED DESCRIPTION

Photo editing menu systems for digital cameras are disclosed for adding creative effects to a user's digital images while still on the user's camera. Exemplary photo editing menu systems may be implemented as an easy-to-use user interface displayed on the digital camera and navigated by the user with conventional camera controls (e.g., arrow buttons and zoom levers already provided on the camera). The user needs little, if any, knowledge about photo editing, and does not need special software for their PC to add creative effects to their digital images. The digital images can be edited on the camera and can then be transferred directly to the user's PC (e.g., for sharing via email), printer, and/or photo processing station (e.g., Internet or store-based) to generate prints without needing any additional editing by the user.

Exemplary digital cameras implementing photo editing menu systems are portable. That is, the user can generate digital images, edit/add effects to their digital images, and export the digital images without the need for a PC using only the digital camera.

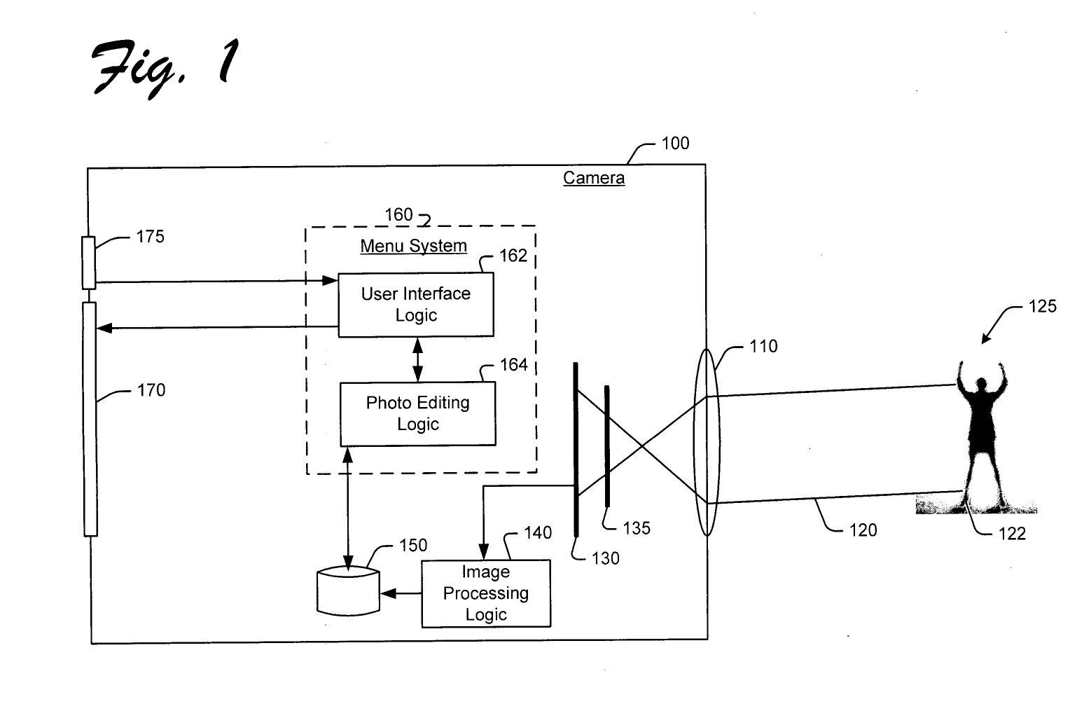

FIG. 1 is a block diagram of an exemplary digital camera 100 which may implement photo editing menu systems. Exemplary digital camera 100 may include a lens 110 positioned in the digital camera 100 to focus light 120 reflected from one or more objects 122 in a scene 125 onto an image capture device or image sensor 130 when a shutter 135 is open (e.g., for image exposure). Exemplary lens 110 may be any suitable lens which focuses light 120 reflected from the scene 125 onto image sensor 130.

Exemplary image sensor 130 may be implemented as a plurality of photosensitive cells, each of which builds-up or accumulates an electrical charge in response to exposure to light. The accumulated electrical charge for any given pixel is proportional to the intensity and duration of the light exposure. Exemplary image sensor 130 may include, but is not limited to, a charge-coupled device (CCD), or a complementary metal oxide semiconductor (CMOS) sensor.

Camera system 100 may also include image processing logic 140. In digital cameras, the image processing logic 140 receives electrical signals from the image sensor 130 representative of the light 120 captured by the image sensor 130 during exposure to generate a digital image of the scene 125. The digital image may be stored in the camera's memory 150 (e.g., a removable memory card).

Shutters, image sensors, memory 150, and image processing logic, such as those illustrated in FIG. 1, are well-understood in the camera and photography arts. These components may be readily provided for digital camera 100 by those having ordinary skill in the art after becoming familiar with the teachings herein, and therefore further description is not necessary.

Digital camera 100 may also include a photo editing menu system 160. In an exemplary embodiment, photo editing menu system 160 is implemented in program code (e.g., firmware and/or software) residing in memory on the digital camera 100 and executable by a processor in the digital camera 100, such as the memory and processor typically provided with commercially available digital cameras. The photo editing menu system 160 may include user interface logic 162 and photo editing logic 164.

The photo editing logic 164 may be operatively associated with the memory 150 for accessing digital images (e.g., reading the images stored in memory 150 by image processing logic 140 or writing the images generated by the photo editing logic 164). Photo editing logic 164 may include program code for applying various photo creative effects to the digital images stored on the camera 100. The photo editing logic may also be operatively associated with the user interface logic 162.

User interface logic 162 may be operatively associated with a user input/output (IO) subsystem. In an exemplary embodiment, the user 10 subsystem includes a display 170 and one or more camera controls 175 already provided on many commercially available digital cameras. Such an embodiment reduces manufacturing costs (e.g., by not having to provide additional hardware for implementing the menu system 160), and enhances usability (e.g., by not overwhelming the user with another IO subsystem).

During operation, the user interface logic 162 displays an image editing menu on the digital camera (e.g., on display 170). User interface logic 162 also receives input (e.g., via one or more of the camera controls 175) identifying user selection(s) from the image editing menu. The photo editing logic 164 may apply one or more creative effects to a digital image stored in the digital camera (e.g., in memory 150) based on selection(s) from the image editing menu.

Optionally, a copy of the original image is used for adding creative effects to a digital image stored on the camera. For example, the new image may be viewed by the user directly after the original image so that the user can readily see both the original image and the modified image. Exemplary photo editing menus and creative effects are described in more detail below.

Before continuing, it is noted that the digital camera 100 shown and described above with reference to FIG. 1 is merely exemplary of a camera which may implement photo editing menu systems. The photo editing menu systems described herein are not intended to be limited only to use with the digital camera 100. Other embodiments of cameras which may implement photo editing menu systems are also contemplated.

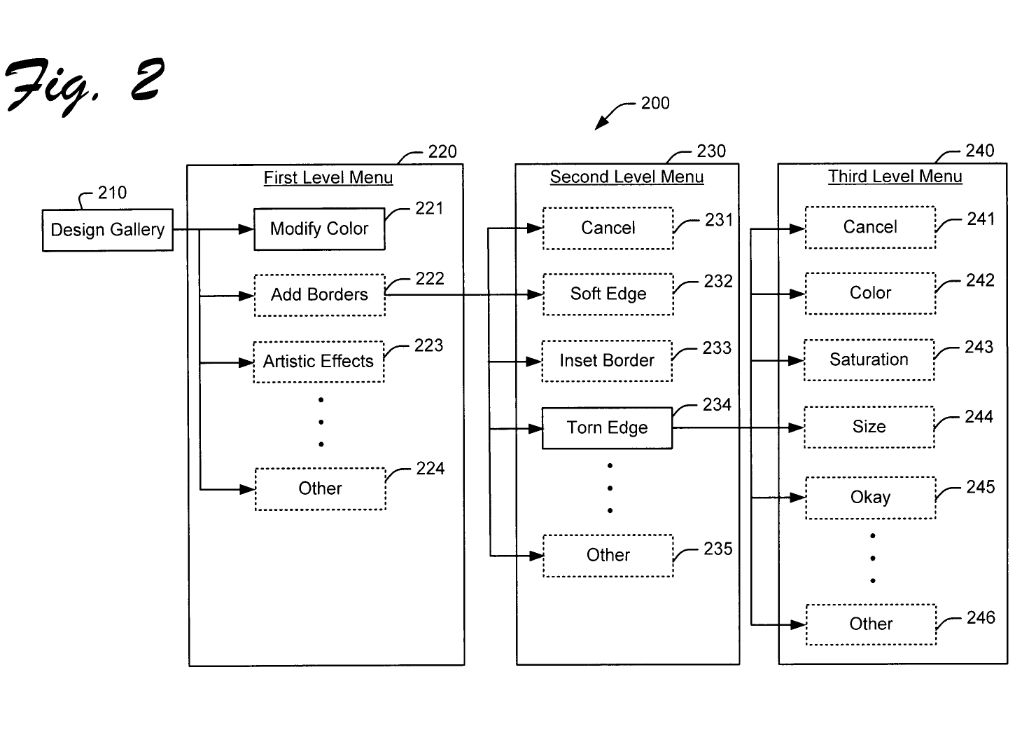

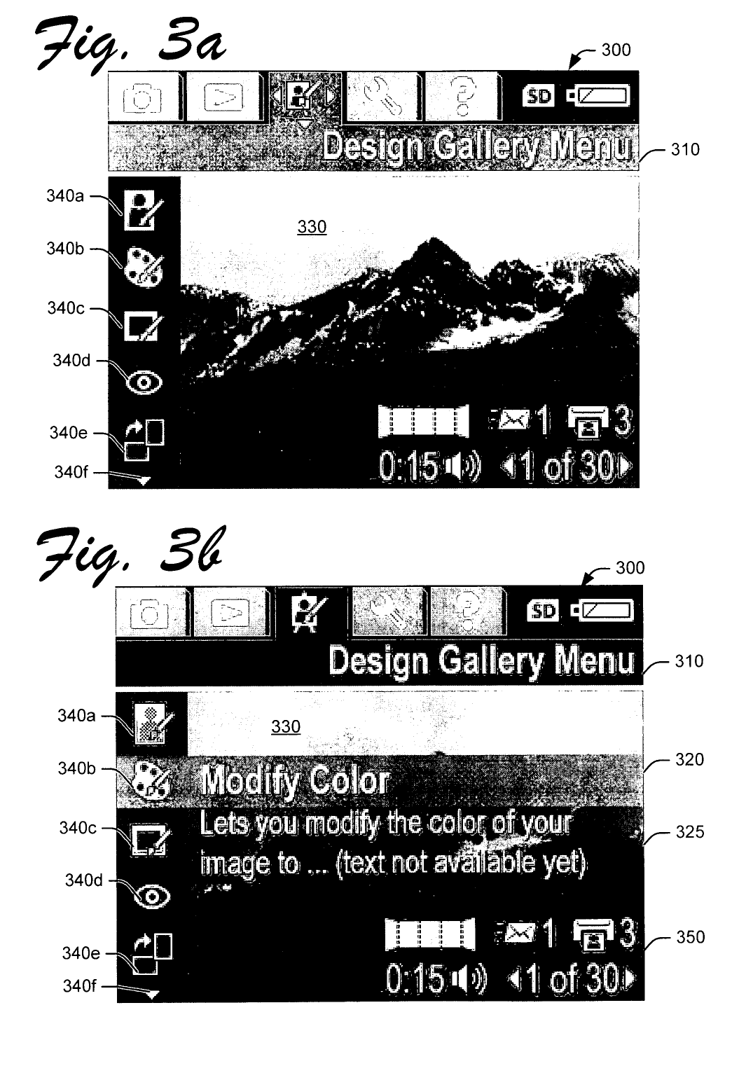

FIG. 2 is a process flow diagram illustrating implementation of exemplary photo editing menu systems in a digital camera (e.g., by the user interface logic 162 in camera 100 shown in FIG. 1). In an exemplary embodiment, the photo editing menu system 200 may be accessed by a user selecting the design gallery menu option 210. The photo editing menu system 200 may then be navigated by a user making selections from any of a variety menus options.

In an exemplary embodiment, the photo editing menu system 200 includes a first-level menu 220 which may be accessed by selecting the design gallery menu option 210. Photo editing menu system 200 also includes a second-level menu 230 and third level menu 240 which may be accessed by selecting various menu options in the higher level menus. For example, the second-level menu 230 is illustrated in FIG. 2 as being accessed from the Add Borders menu option 222 in the first level menu. Other second-level menus (not shown in FIG. 2) may also be accessed from the menu options 223-224 in the first-level menu 220. The third level menu 240 is illustrated in FIG. 2 as being accessed from the Tom Edge menu option 234 in the second level menu 230. Again, other third level menus (not shown in FIG. 2) may also be accessed from the menu options 232-233 and 235 in the second-level menu 230.

In the exemplary embodiment illustrated in FIG. 2, the user may select a menu option 242-246 from the third-level menu which executes a function (e.g., add creative effects to the digital image). In other embodiments, however, the user may select a menu option from any of the menu levels which execute a function. The user may also back up a level. For example, the user may back up from the third level menu 240 to the second level menu by selecting the Cancel menu option 241. The user may also back up from the second level menu 230 to the first level menu 220 by selecting the Cancel menu option 231. Other exemplary menu options are explained in more detail below with reference to FIGS. 3-5.

It is noted that photo editing menu systems are not limited to use with any number of menu levels. That is, the photo editing menu system may include more menu levels (not shown in FIG. 2) and/or fewer menu levels. In addition, every menu level does not need to have the same number of lower-level menus. Some menu options may have one or more lower-level menus, while other menu options may not have any lower-level menus.

FIG. 3 are screenshots of a user interface 300 illustrating (a) an exemplary design gallery menu 310, and (b) a highlighted selection 320 in the exemplary design gallery menu. The design gallery menu 310 includes menu options which enable the user to modify the digital images stored on the camera. Menu items may appear active or inactive, e.g., depending at least in part on the type of image being shown behind the menu.

In an exemplary embodiment, the user may access the design gallery menu 310 from a display on the digital camera by pressing the Menu/OK button while in Playback mode. One of the options in the camera menu is the design gallery menu 310. The design gallery menu is displayed as a layer overlaid on the current digital image 330 being displayed, as shown in FIGS. 3a-b.

The user may select the digital image before entering the design gallery menu 310. Optionally, the user may also scroll through digital images stored on the camera (e.g., using the left right arrow buttons on the digital camera) after entering the design gallery menu 310. In any event, the creative effect is typically applied to the selected (displayed) digital image.

Icons 340a-e representing each menu item appear down the left hand side of the design gallery menu 310. The design gallery menu 310 may include the following exemplary menu options: Apply Artistic Effects 340a, Modify Color 340b, Add Borders 340c. Other menu options such as Remove Red Eye 340d, Rotate Image 340e, and More Options 340f may also be displayed for the user.

The menu item title 320 may be displayed to the right of each menu icon 340a-e when the menu icon is selected by the user to identify the menu options for the user, as illustrated in FIG. 3b. In addition, instructions or help 325 may be displayed, e.g., under the current menu selection 320. The same information 350 that is shown on Playback images may also be displayed, e.g., along the bottom of the design gallery menu 310.

While the design gallery menu 310 is displayed, the camera controls may be dynamically assigned various functions. Exemplary camera buttons and the corresponding functions that may be assigned to those camera controls are provided for purposes of illustration in Table 1.

TABLE 1
Exemplary Camera Controls For Design Gallery

| Camera Control | Functions |
|---|---|
| Still capture or | Exit sub-menu and Playback menu; switch to new mode. |
| Video capture mode | |
| Left/right arrows | Scroll to previous/next image. |
| Up/down arrows | Scroll to previous/next menu choice |
| Menu/OK button | Select highlighted menu choice, go to sub-menu for selected |
| | Design Gallery feature. |
| Back button | Exit sub-menu and return to main Playback menu. |
| Shutter button | Inactive |
| Zoom levers | Zoom In: Exit sub-menu, switch to Magnify view for current |
| | image. |
| | Zoom Out: Exit sub-menu, switch to Thumbnail view. |
| Flash button | Inactive |
| Photosmart Express button | Exit Playback menu, switch to Photosmart Express menu. |
| Delete button | Exit sub-menu, go to Delete Confirmation screen for image. |

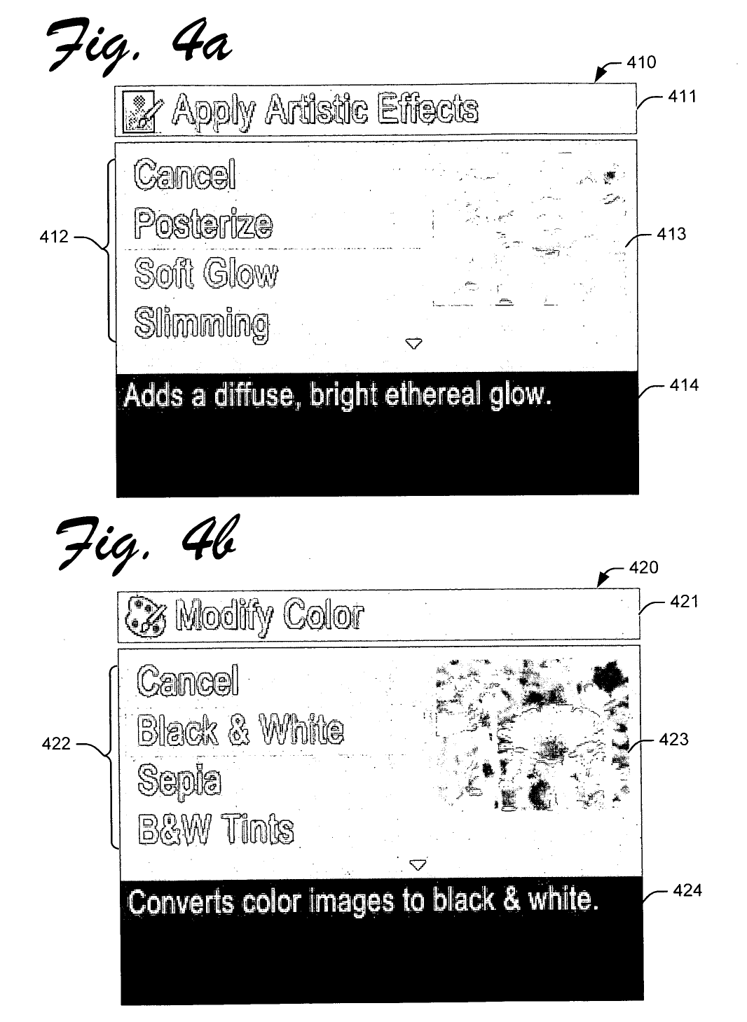

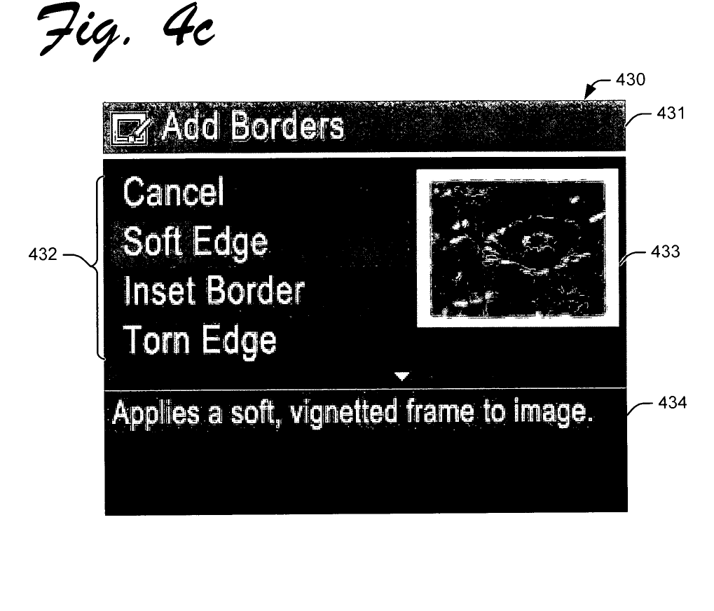

As discussed above with reference to FIG. 2, the user may select various second-level menus from the design gallery menu 310. Exemplary second-level menus are described in more detail below with reference to FIG. 4.

FIG. 4 are screenshots of a user interface illustrating (a) an exemplary apply artistic effects menu 410, (b) an exemplary modify color menu 420, and (c) an exemplary add borders menu 430. Various menu options may be selected from the menus, e.g., by scrolling through the menu options to highlight the desired menu option and then actuating a camera control to confirm the selection.

The exemplary apply artistic effects menu 410 is shown in FIG. 4a. Selecting apply artistic effects menu 410 (e.g., from the design gallery menu 310 shown in FIG. 3) displays a title 411, a list of available creative effects 412, a thumbnail preview 413 and instructional text 4114. Optionally, the preview thumbnail 413 may be updated each time a new artistic effect is scrolled to in the menu so that the user can see changes to the digital image in real-time.

Exemplary creative effects 412 available from the apply artistic effects menu 410 may include: ink dots, cartoon, watercolor, center focus, posterize, retro, soft glow, vintage, slimming, sky color, ground color, kaleidoscope, and solarize, to name only a few examples. The user may use the up/down arrow buttons on the camera to scroll through the available creative effects 412.

The user may press the Menu/OK button on the camera to select the desired creative effect 412. The user's selection may advance the menu to a lower-level menu having further settings for the selected creative effect 412. Exemplary camera controls for applying artistic effects to the digital image, and the corresponding artistic effects are provided in Table 2 for purposes of illustration.

TABLE 2
Exemplary Camera Controls For Artistic Effects

| | Right/Left | Up/Down | | |
|---|---|---|---|---|
| Effect | Arrows | Arrows | Zoom Lever | Help Text |
| Posterize | None; inactive | None; inactive | None; inactive | Creates a high- |
| | | | | contrast, flat- |
| | | | | toned effect. |
| Soft Glow | None, inactive | None, inactive | None; inactive | Adds a diffuse, |
| | | | | bright ethereal |
| | | | | glow. |
| Slimming | Compression | None, inactive | None; inactive | Compresses |
| | amount | | | centered subjects |
| | | | | for a slimmer |
| | | | | look. |
| Kaleidoscope | Move center | Move center | None; inactive | Mirrors the |
| | point | point | | image in four |
| | | | | directions. |
| Ink Dots | Color | Ink dots | None; inactive | Uses dots to |
| | | [meter overlay] | | simulate the art |
| | | | | technique of |
| | | | | pointillism. |
| Cartoon | Color | Line intensity | None; inactive | Simulates a |
| | | [meter overlay] | | highly graphical |
| | | | | comic book |
| | | | | image. |
| Watercolor | Brightness | Saturation | None; inactive | Simulates a |
| | | [meter overlay] | | watercolor |
| | | | | painting. |
| Center Focus | None; inactive | Edge blur | None; inactive | Creates a |
| | | [meter overlay] | | feathered blur |
| | | | | radiating from a |
| | | | | sharp center to a |
| | | | | blurred edge. |
| Posterize | Posterization | None; inactive | None; inactive | Creates a high- |
| | level | | | contrast, flat- |
| | | | | toned effect. |
| Retro | Ink Color | Paper Color | Brightness | Creates a two- |
| | | [meter overlay] | | color, high- |
| | | | | contrast look |
| | | | | from the 70s. |
| Soft Glow | Brightness | Haze | None; inactive | Adds a diffuse, |
| | | [meter overlay] | | bright ethereal |
| | | | | glow. |
| Vintage | None; inactive | Aging level | None; inactive | Adds an aged, |
| | | [meter overlay] | | scratched look. |
| Slimming | Compression | None; inactive | None; inactive | Compresses |
| | amount | | | centered subjects |
| | | | | for a slimmer |
| | | | | look. |
| Sky Color | Color | Fade | Saturation | Enhances sky |
| | (mapped to | | [meter overlay] | with a feathered |
| | tones/tints) | | | color that fades |
| | | | | from the top |
| | | | | down. |
| Ground | Color | Fade | Saturation | Enhances |
| Color | (mapped to | | [meter overlay] | landscapes with a |
| | tones/tints) | | | feathered color |
| | | | | that fades from |
| | | | | the bottom up. |
| Kaleidoscope | Move center | Move center | None; inactive | Mirrors the |
| | point | point (5 levels) | | image in four |
| | | | | directions. |
| Solarize | Color | Intensity | None; inactive | Creates a partial |
| | | [meter overlay] | | reversal of tones |
| | | | | and emphasizes |
| | | | | outlines. |

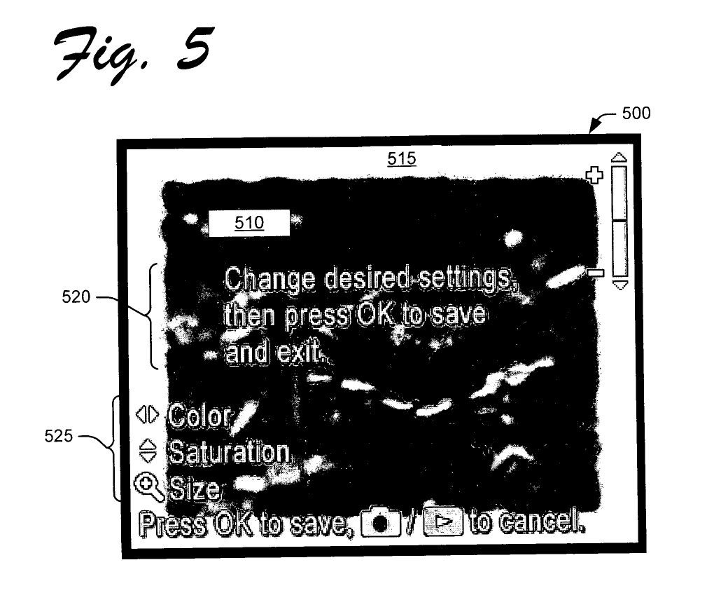

After the user selects a creative effect 412 from the apply artistic effects menu 410, the user may press Menu/OK to advance to the creative submenu (see, e.g., FIG. 5) for applying the selected artistic effect to the digital image where the new image may be displayed for the user (e.g., behind the menu options). Pressing Menu/OK from the creative submenu then saves the image as a new file on the camera system. Optionally, the user may press the Back button to return to a higher menu level without saving the changes.

The exemplary modify color menu 420 is shown in FIG. 4b. Selecting modify color menu 420 (e.g., from the design gallery menu 310 shown in FIG. 3) displays a title 421, a list of available creative effects 422, a thumbnail preview 423 and instructional text 424. Optionally, the preview thumbnail 423 may be updated each time a new color effect is scrolled to in the menu so that the user can see changes to the digital image in real-time.

Exemplary creative effects 422 available from the modify color menu 420 may include: change color to black & white, sepia, or another color tone. Selecting a color may display a third-level menu for the selected color option. Exemplary camera controls for applying creative effects 432 to the digital image, and the corresponding color effects are provided in Table 3 for purposes of illustration.

TABLE 3
Exemplary Controls For Color Effects

| | Right/Left | Up/Down | | |
|---|---|---|---|---|
| Effect | Arrows | Arrows | Zoom Lever | Help Text |
| Black and | Contrast | None; inactive | None; inactive | Converts color |
| White | | | | images to black and |
| | | | | white. |
| Sepia | Strength | None; inactive | None; inactive | Converts image |
| | | | | to a brownish |
| | | | | tone to look |
| | | | | old-fashioned. |
| BW Tints | Color | Saturation | None; inactive | Applies color |
| | | [meter overlay] | | tones on a black |
| | | | | & white version |
| | | | | of an image. |
| Color Tints | Tint Color | Tint saturation | Mute original | Adds an extra |
| | | [meter overlay] | image | color layer to |
| | | | | images to create |
| | | | | a mood or feeling. |
| Black and | None; inactive | None; inactive | None; inactive | Converts color |
| White | | | | images to black |
| | | | | and white. |
| Sepia | None; inactive | None; inactive | None; inactive | Converts image |
| | | | | to a brownish |
| | | | | tone to look |
| | | | | old-fashioned. |
| BW Tints | Color (5 levels) | None; inactive | None; inactive | Applies color |
| | | | | tones on a black |
| | | | | & white version of an |
| | | | | image. |

After the user selects a creative effect 422 from the modify color menu 420, the user may press Menu/OK to advance to the creative submenu (see, e.g., FIG. 5) for applying the selected color effect to the digital image where the new image may be displayed for the user (e.g., behind the menu options). Pressing Menu/OK from the creative submenu then saves the image as a new file on the camera system. Optionally, the user may press the Back button to return to a higher menu level without saving the changes.

The exemplary add borders menu 430 is shown in FIG. 4c. Selecting add borders menu 430 (e.g., from the design gallery menu 310 shown in FIG. 3) displays a title 431, a list of available creative effects 432, a thumbnail preview 433 and instructional text 434. Optionally, the preview thumbnail 433 may be updated each time a new border effect is scrolled to in the menu so that the user can see changes in real-time.

Exemplary creative effects 432 available from the add borders menu 430 may include: soft edge, inset border, torn edge, burn edge, spatter, oval, circle, rectangle, rounded rectangle, square, to name only a few examples. The user may use the up/down arrow controls on the camera to scroll through the available creative effects 432.

The user may press the Menu/OK button on the camera to select the desired creative effect 432. The user's selection may advance the menu to a lower-level menu having further setting for the selected creative effect 432. Exemplary camera controls for adding border effects to the digital image, and the corresponding border effects are provided in Table 4 for purposes of illustration.

TABLE 4
Exemplary Camera Controls For Border Effects

| | Right/Left | Up/Down | | |
|---|---|---|---|---|
| Effect | Arrows | Arrows | Zoom Lever | Help Text |
| Soft Edge | Color | Saturation | Size | Applies a soft, |
| | | [meter overlay] | | vignetted frame to |
| | | | | the image. |
| Inset Border | Color | Saturation | Size | Image extends |
| | | [meter overlay] | | beyond the inset |
| | | | | frame. |
| Torn Edge | Color | Tear Roughness | Size | Creates random tears |
| | | | | for an uneven border |
| | | | | effect. |
| Burn Edge | Color | Burn opacity | Size | Creates a border |
| | | [meter overlay] | | with darkened areas |
| | | | | that appear burned. |
| Spatter | Color | Droplet size | Border size | Creates an edge that |
| | | | | appears to dissolve |
| | | | | into the paper, like |
| | | | | spray. |
| Oval | Color | Saturation | Size | Adds an oval matte |
| | | [meter overlay] | | border with beveled |
| | | | | edges. |
| Circle | Color | Saturation | Size | Adds a circular |
| | | [meter overlay] | | matte border with |
| | | | | beveled edges. |
| Rectangle | Color | Saturation | Size | Adds a rectangular |
| | | [meter overlay] | | matte border with |
| | | | | beveled edges. |
| Rounded | Color | Saturation | Size | Uses a rectangle |
| Rectangle | | [meter overlay] | | with soft corners for |
| | | | | the matte border. |
| Square | Color | Saturation | Size | Adds a square matte |
| | | [meter overlay] | | border with beveled |
| | | | | edges. |
| All border | Color selection | Border size | NA | Differs by border. |
| types | | | | |

After the user selects a creative effect 432 from the add border 430, the user may press Menu/OK to advance to the creative submenu (see, e.g., FIG. 5) for applying the selected border effect to the digital image where the new image may be displayed for the user (e.g., behind the menu options). Pressing Menu/OK from the creative submenu then saves the image as a new file on the camera system. Optionally, the user may press the Back button to return to a higher menu level without saving the changes.

FIG. 5 is a screenshot 500 showing an exemplary preview image 510 as it may be displayed for a user on a digital camera implementing photo editing menu systems. The preview image 510 may be displayed so that the user can see the creative effect (e.g., border 515), with instructive text 520 and 525 for modifying, or accepting/rejecting the border 515. Optionally, the instructive text may be displayed until the user operates a camera control (e.g., presses a button on the camera). After the user operates a camera control, the text may be removed so that the user can better see the preview image 510 and creative effects (e.g., border 515, color, or artistic effects).

The user may operate camera controls (e.g., as indicated by the instructive text 525) to modify the border 515. For example, the user may press the left/right arrow buttons on the camera to change color, up/down arrow buttons on the camera to change saturation, and zoom button on the camera to increase or decrease the border width.

Other camera controls for various menus (e.g., menus 410, 420, and 430 shown in FIGS. 4a-c, respectively) are provided in Table 5 for purposes of illustration.

TABLE 5
Exemplary Button Functionality for Design Gallery sub-menus

| | Artistic Effects, Modify | |
|---|---|---|
| | Color, Add borders sub- | |
| Button | menus | Creative sub-menu |
| Still Capture or Video | Cancel Design Gallery | Cancel Design Gallery |
| Capture mode | effects sub-menu; switch to | operation; switch to new |
| | new mode. | mode. |
| Left/Right arrows | Inactive | Adjust control, if defined. |
| Up/down arrows | Scrolls through list of | Adjust control, if defined. |
| | effects/options | (Associated with the meter.) |
| Menu/OK button | Confirms selection; goes to | Apply changes, saving new |
| | creative submenu | image and return to main |
| | | Playback menu with new |
| | | image shown beneath menu. |
| Back button | Cancel the sub-menu and | Cancel without saving |
| | return to the Design Gallery | effects; exit Design Gallery |
| | sub-menu. (up one level) | Creative sub-menu and |
| | | return to Design Gallery sub- |
| | | menu with current image displayed. |
| Shutter button | Inactive | Inactive |
| Zoom levers | Inactive | Adjust control, if defined. |
| Flash button | Inactive | Inactive |
| Photosmart Express | Cancel Design Gallery | Cancel Design Gallery |
| button | effects sub-menu; switch to | operation; switch to |
| | Photosmart Express menu. | Photosmart Express menu |
| Delete button | Inactive | Inactive |

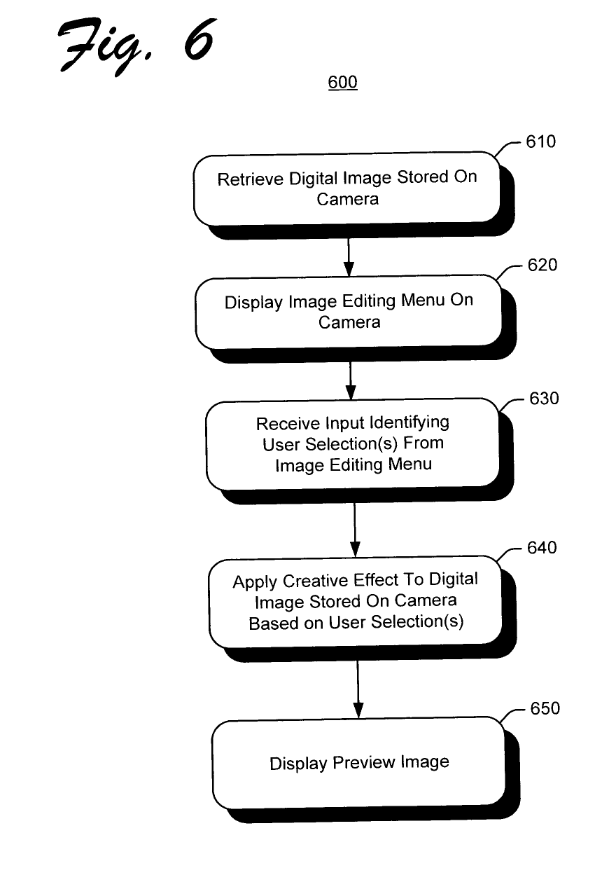

FIG. 6 is a flowchart illustrating exemplary operations which may implement photo editing menu systems for digital cameras. The operations may be embodied as logic instructions on one or more computer-readable medium. When executed on a processor in the camera, the logic instructions implement the described operations. In an exemplary embodiment, the components and connections depicted in the figures may be implemented.

In operation 610, a digital image stored on the camera is retrieved, e.g., from memory. In operation 620, an image editing menu is displayed on the camera. In operation 630, input identifying one or more user selections from the image editing menu are received. For example, user interface logic may receive electrical signals from a user operating a camera control.

In operation 640, a creative effect may be applied to the digital image stored on the camera, based at least in part on the user selection(s). For example, photo editing logic may be executed in response to the user interface logic receiving user selection(s) to apply one or more of the exemplary creative effects described above. In operation 650, a preview image may be displayed for the user showing the creative effect(s) applied during operation 640.

The operations shown and described herein are provided to illustrate exemplary embodiments for implementing photo editing menu systems in cameras. The operations are not limited to the ordering shown. Still other operations may also be implemented.

In an exemplary embodiment, a digital image selected by the user may be analyzed by the photo editing logic to automatically determine an effect that complements the selected digital image. For purposes of illustration, the photo editing logic (or other logic) may analyze the digital image, and based on colors in the digital image automatically apply sepia tones. The image may be displayed with sepia tones for the user and the user may then be prompted to accept/reject the automatic selection. Other examples are also contemplated, as will be readily appreciated by those having ordinary skill in the art after becoming familiar with the teachings herein.

In another exemplary embodiment, the photo editing logic (or other logic) may store a separate copy of the digital image before applying creative effects to the selected digital image. Accordingly, the user can revert back to the original digital image if the user decides that they do not like the creative effects they have chosen without having to undo all of the changes.

It is noted that the exemplary embodiments shown and described are provided for purposes of illustration and are not intended to be limiting. Still other embodiments of photo editing menu systems for cameras are also contemplated.

1. A photo editing menu system for a digital camera comprising:
computer-readable storage for storing at least one digital image in the digital camera;
a display device for displaying an image editing menu as a layer over at least one digital image being displayed on the digital camera;
at least one camera control on the digital camera for receiving input identifying at least one user selection from the image editing menu; and
photo editing logic executing to apply at least one creative effect to the at least one digital image being displayed on the digital camera based on the at least one user selection from the image editing menu.

2. The photo editing menu system of claim 1, further comprising interface logic executing to display the image editing menu over the at least one digital image on the digital camera.

3. The photo editing menu system of claim 1, further comprising interface logic executing to identify the at least one user selection from the image editing menu based on input from the at least one camera control.

4. The photo editing menu system of claim 1, further comprising a multi-level menu with menu options for a user to apply creative effects to the at least one digital image.

5. The photo editing menu system of claim 1, wherein the at least one camera control is provided on the digital camera for standard camera operations, the at least one camera control assigned menu navigation functions based on a position in the image editing menu.

6. The photo editing menu system of claim 1, wherein the at least one camera control is provided on the digital camera for standard camera operations, the at least one camera control assigned editing functions based on menu selections in the image editing menu.

7. A method for applying creative effects to digital images with minimal user effort, comprising:
displaying an image editing menu as a layer over a digital image displayed on a camera;
receiving user input identifying at least one selection from the image editing menu; and
applying at least one of the creative effects to the digital image displayed on the camera based on the at least one selection from the image editing menu.

8. The method of claim 7, further comprising making a copy of the digital image stored in the camera before applying the at least one of the creative effects to preserve the digital image as an original.

9. The method of claim 7, further comprising automatically selecting one of the creative effects complementing at least one feature of the digital image.

10. The method of claim 7, further comprising exporting the digital image after applying the at least one creative effects for generating a printed image without need for further editing of the digital image.

11. The method of claim 7, further comprising dynamically assigning menu navigation functions to standard camera controls for navigating the image editing menu.

12. The method of claim 7, further comprising dynamically assigning editing functions to standard camera controls for applying the at least one of the creative effects.

13. The method of claim 7, further comprising displaying a preview image after applying the at least one of the creative effects for the user to accept or reject before saving the digital image.

14. A computer program product encoding computer programs for executing a menu system on a camera, the computer process comprising executable program code for:
displaying a multi-level image editing menu as a layer over a digital image being displayed on the camera;
identifying at least one selection from the multi-level image editing menu based on user input; and
applying at least one creative effects to the digital image being displayed on the camera based on a selection from at least one level of the multi-level image editing menu.

15. The computer program product of claim 14, further comprising executable program code for making a copy of the digital image on the camera before applying the at least one creative effect.

16. The computer program product of claim 14, further comprising executable program code for automatically analyzing the digital image being displayed on the camera to identify at least one feature of the digital image.

17. The computer program product of claim 16, further comprising executable program code for automatically selecting a creative effect complementing the at least one feature of the digital image.

18. The computer program product of claim 14, further comprising executable program code for exporting the digital image without need for further modification after applying the at least one creative effect.

19. The computer program product of claim 14, further comprising executable program code for assigning different menu navigation functions to standard camera controls based at least in part on a current level being navigated in the multi-level image editing menu.

20. The computer program product of claim 14, further comprising executable program code for assigning different editing functions to a standard camera controls based at least in part on a current level being navigated in the multi-level image editing menu.
